(19) United States
(12) Patent Application Publication
(10) Pub. No.: US 2010/0091503 A1
(43) Pub. Date: Apr. 15, 2010

(54) LAMP DEVICE

(76) Inventor: Benny L. Kuo, Tainan City (TW)

Correspondence Address: CHRISTIE, PARKER & HALE, LLP, PO BOX 7068, PASADENA, CA, 91109-7068, US

(21) Appl. No.: 12/251,318

(22) Filed: Oct. 14, 2008

(51) Int. Cl. F21V 15/00

(52) U.S. Cl. 362/362

(57) ABSTRACT

A lamp device includes a base plate adapted to be fixed onto a mounting wall, a swivelable carrier having a carrier body swivelably mounted on the base plate about a central axis and retained at a retaining position with respect to the base plate by means of a first slidably engaging unit, and an angularly positionable mounting frame disposed to be swiveled with the carrier body, and having a rim body for mounting a lighting module. The mounting frame has a hinge shaft hingedly mounted on a joint lug of the carrier such that the rim body, together with the lighting module, is turnable relative to the carrier body and is retained at a tilted position by means of a second slidably engaging unit. With simple swiveling and turning operations, the angle and direction of the lighting module can be changed.

### BACKGROUND OF THE INVENTION

1. Field of the Invention

This invention relates to a lamp device, more particularly to a lamp device adapted to be fixed onto a mounting wall, such as a projecting lamp.

2. Description of the Related Art

In U.S. Pat. No. 7,192,167 B1, entitled “Lamp Device,” filed by the applicant, there is disclosed a lamp device which is operable to change the orientation of a lamp unit thereof. The lamp device is adapted to be secured onto a mounting wall. The orientation of a lamp mounting unit can be changed by pressing an operating plate so as to vary the direction of a light beam emanating from the lamp unit. However, the lamp device has a relatively large number of components, thereby resulting in inconvenience during assembly and relatively high manufacturing costs.

### SUMMARY OF THE INVENTION

An object of the present invention is to provide a lamp device which is convenient to assemble and manufacture and which can be easily operated to change the angle and direction of a lighting module thereof.

According to this invention, the lamp device includes a base plate adapted to be fixed onto a mounting wall, and having a major plate surface opposite to the mounting wall along a central axis. A swivelable carrier has a carrier body that has front and rear major carrier surfaces opposite to each other along the central axis, and a joint lug disposed outwardly and radially of the carrier body. A revolution enabling unit is disposed between the base plate and the rear major carrier surface to enable the carrier body to be swivelable relative to the base plate about the central axis. The revolution enabling unit includes a socket member which has an inner tubular surface surrounding the central axis, and a plug member which is configured to be fitted to the socket member such that the plug member is prevented from disengaging from the socket member along the central axis during swiveling movement of the carrier body. A first slidably engaging unit is disposed between the inner tubular surface and the swivelable carrier, and is configured to guard against the swiveling movement of the carrier body relative to the inner tubular surface at a selected one of a plurality of retaining positions. An angularly positionable mounting frame is disposed to be swiveled with the carrier body. The mounting frame includes a rim body surrounding the central axis, and a hinge shaft which is disposed outwardly of the rim body and which is hingedly mounted on the joint lug about the hinge axis. Thus, the rim body is turnable relative to the carrier body about the hinge axis to a selected one of a plurality of tilted positions. The hinge shaft has a surrounding outer surface revolveable about the hinge axis. A second slidably engaging unit is disposed to guard against revolving movement of the surrounding outer surface relative to the joint lug at the selected tilted position. A lighting module is surrounded by and secured to the rim body.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of the preferred embodiment of a lamp device according to this invention;

FIG. 2 is an exploded perspective view of the preferred embodiment;

FIG. 3 is a sectional view of the preferred embodiment;

FIG. 4 is an exploded perspective view showing an assembly of a base plate, a swivelable carrier, and a first slidably engaging unit of the preferred embodiment;

FIG. 5 is an exploded perspective view showing an assembly of the swivelable carrier, an angularly positionable mounting frame, and a second slidably engaging unit of the preferred embodiment;

FIG. 6 is a fragmentary perspective view of a portion of the preferred embodiment; and

FIG. 7 is a sectional view showing a lighting module of the preferred embodiment in a tilted position.

### DETAILED DESCRIPTION OF THE PREFERRED EMBODIMENT

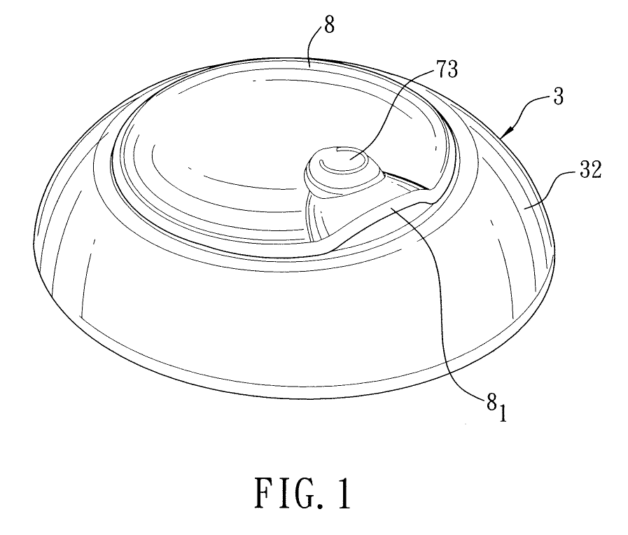

Referring to FIGS. 1 to 3, the preferred embodiment of a lamp device according to the present invention is shown to comprise a base unit 3, a swivelable carrier 4, an angularly positionable mounting frame 6, first and second slidably engaging units, a lighting module 7, and a translucent lamp shade 8.

The base unit 3 includes a base plate 31 and a skirt 32. The base plate 31 is adapted to be fixed onto a mounting wall, such as a ceiling, an upright wall, etc., and has a major plate surface which is opposite to the mounting wall along a central axis (C). The major plate surface has a central region 312 which serves as a socket member 312, and which has an inner tubular surface 314 that surrounds the central axis (C) and that defines a central bore 310 extending through the base plate 31. The skirt 32 surrounds the central axis (C), and extends rearwardly to terminate at a flared rear edge 321 which has engaging hooks 3211 securely mounted on a surrounding region 311 of the major plate surface of the base plate 31. Further, the skirt 32 extends forwardly to terminate at a surrounding front edge 322 which cooperates with the base plate 31 to define a mounting space 30.

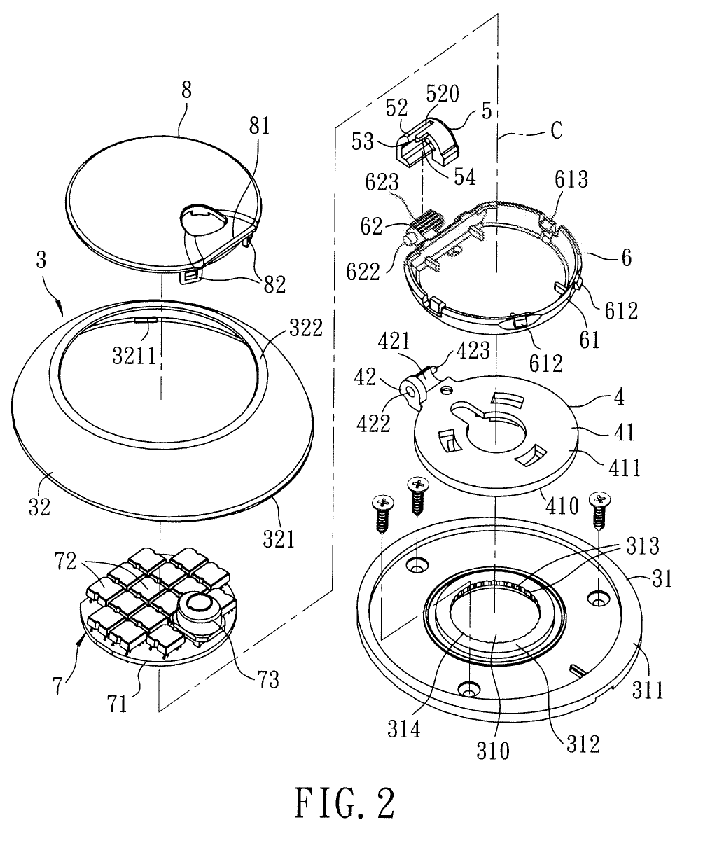

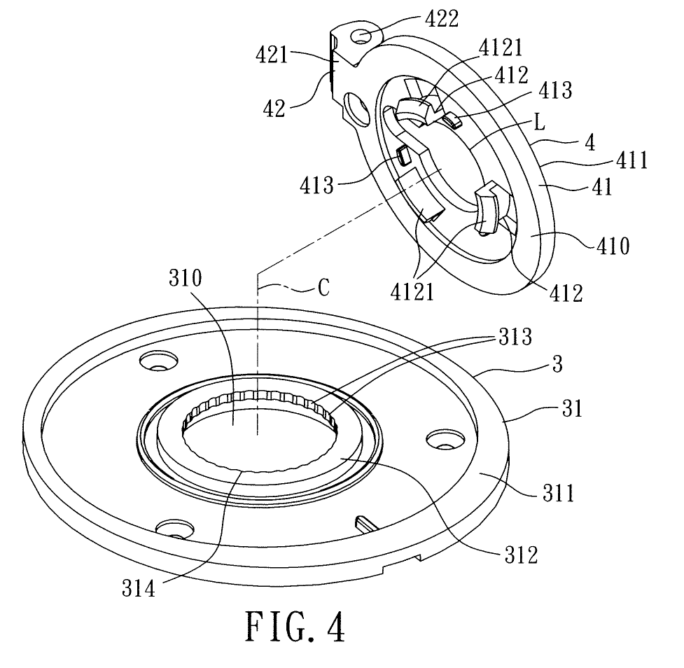

Referring to FIGS. 2 to 4, the swivelable carrier 4 has a carrier body 41 which is mounted in the mounting space 30, which is disposed normal to the central axis (C), and which has front and rear major carrier surfaces 411,410 opposite to each other along the central axis (C), and a joint lug 42 which is disposed outwardly and radially of the carrier body 41. The joint lug 42 has a joint surface 422 which extends angularly about a hinge axis, a supporting portion 421 which extends from the joint surface 422 along the hinge axis, and an insert portion 423 which extends from the supporting portion 421 away from the joint surface 422.

A revolution enabling unit includes the socket member 312 and a plug member which has a plurality of tongues 412 angularly displaced from one another along a surrounding contour line (L). Each of the tongues 412 extends from the rear major carrier surface 410, and terminates at a hook end 4121 such that, when the plug member is snap-fitted to the socket member 312, the tongues 412 are fitted in the central bore 310, with the hooked ends 4121 disposed beneath the base plate 31, and such that the surrounding contour line (L) confronts the inner tubular surface 314 in radial directions. By virtue of the revolution enabling unit, the carrier body 41 is swivelable relative to the base plate 31 about the central axis (C). In addition, by virtue of the snap-fit engagement between the hook ends 4121 and the base plate 31, the plug member is prevented from disengaging from the socket member 312 along the central axis (C) during swiveling movement of the carrier body 41.

The first slidably engaging unit includes a plurality of engaging protrusions 413 which extend rearwardly from the rear major carrier surface 410 of the carrier body 41 and which are angularly spaced apart from each other along the surrounding contour line (L), and a plurality of first serrations 313 which are disposed on the inner tubular surface 314 of the central region 312 of the base plate 31 such that the engaging protrusions 413 are angularly displaceable relative to, and frictionally engaged with, the first serrations 313 so as to guard against undesired swiveling movement of the carrier body 41 relative to the inner tubular surface 314 at a selected one of a plurality of retaining positions that are angularly displaced from one another about the central axis (C).

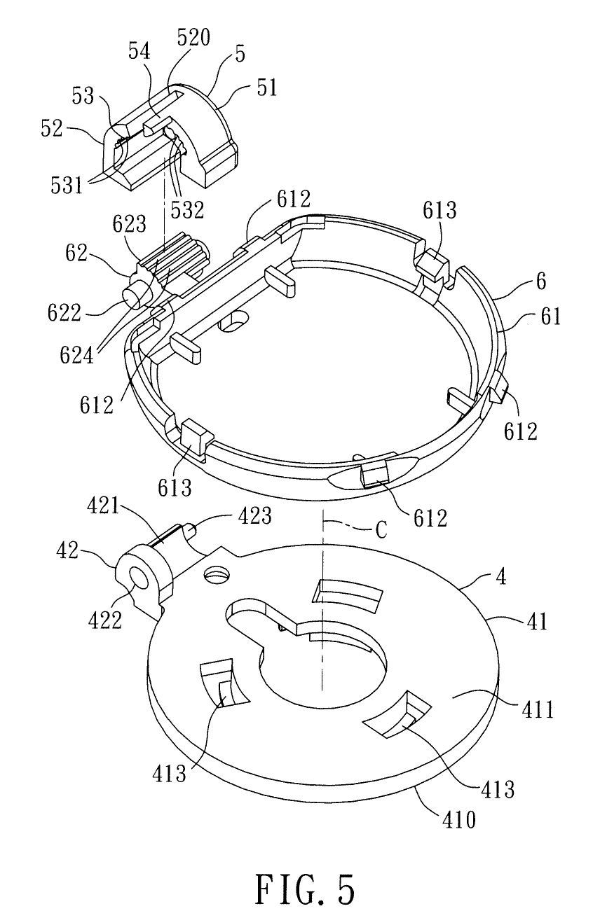

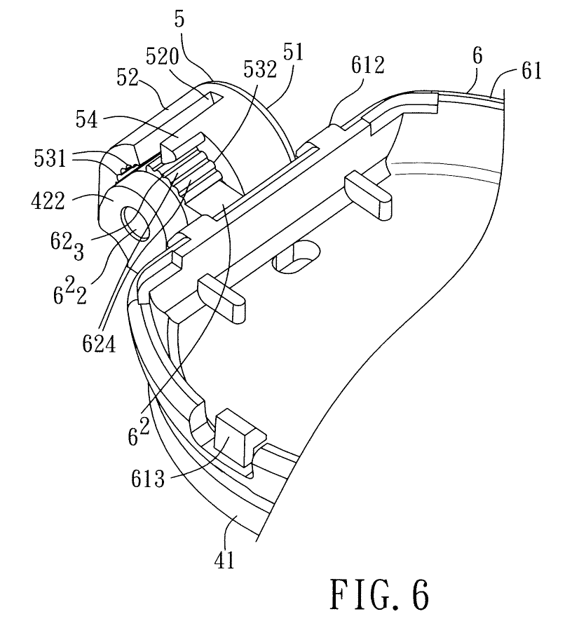

Referring to FIGS. 2, 5 and 6, the angularly positionable mounting frame 6 is disposed in the mounting space 30 to be swiveled with the carrier body 41 about the central axis (C). The mounting frame 6 includes a rim body 61 surrounding the central axis (C), and a hinge shaft 62 which is disposed outwardly of the rim body 61. The rim body 61 has a plurality of outer hooks 612 which are disposed on an outer surface thereof and which are angularly displaced from one another about the central axis (C), and a plurality of inner hooks 613 which are disposed on an inner surface thereof and which are angularly displaced from one another about the central axis (C). The hinge shaft 62 includes a cylindrical body 622 which is pivotably connected to the joint surface 422 about the hinge axis, and a larger-diameter surrounding outer surface 623 which extends from the cylindrical body 622 along the hinge axis so as to be revolveable about the hinge axis. Thus, the rim body 61 is turnable relative to the carrier body 41 about the hinge axis to a selected one of a plurality of tilted positions that are angularly displaced from one another about the hinge axis.

The second slidably engaging unit includes a plurality of second serrations 624 which are disposed on the surrounding outer surface 623 and which are angularly displaced from one another about the hinge axis, and a retaining member 5 which has an anchoring base 51 secured to the insert portion 423 of the joint lug 42, a jaw body 52 extending angularly from the anchoring base 51 about the hinge axis, and a retaining surface 53 that confronts radially and that is serrated to mate with the second serrations 624 in frictional engagement to thereby guard against revolving movement of the surrounding outer surface 623 relative to the joint lug 42 at the selected tilted position. Further, the jaw body 52 has a slit 520 which extends through the retaining surface 53 and in a transverse direction parallel to the hinge axis to divide the retaining surface 53 into left and right retaining regions 531,532 so as to vest the jaw body 52 with a flexibility for facilitating engagement between one of the left and right retaining regions 531,532 and the second serrations 624. Furthermore, the jaw body 52 includes an engaging finger 54 which extends from one of the left and right retaining regions 531,532 in the transverse direction and which is configured to engage a selected one of the second serrations 624 so as to reinforce the engagement between the retaining surface 53 and the second serrations 624 at the selected one of the tilted positions.

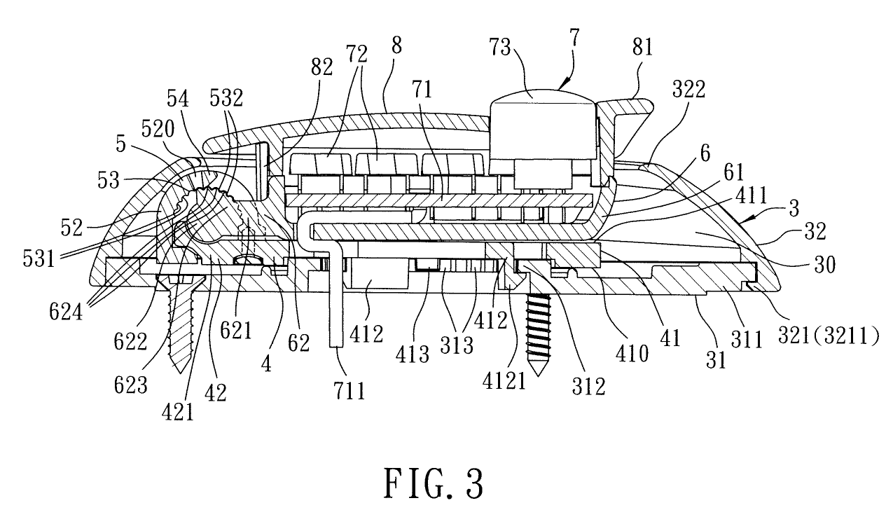

Referring to FIGS. 2 and 3, the lighting module 7 includes a circuit board 71 which is surrounded by the rim body 61 and which is secured to the rim body 61 by the inner hooks 613, a lamp set 72 which is disposed on the circuit board 71, and a switch 73 electrically connected to the circuit board 71. An electric wire 711 extends rearwardly from the circuit board 71 through the carrier body 41 so as to be electrically connected to a power supply (not shown). In this embodiment, the lamp set 72 includes light-emitting diodes (LED).

The translucent lamp shade 8 has a plurality of engaging holes 82 which are angularly displaced from one another about the central axis (C) and which are engaged with the outer hooks 612 so as to be secured to the rim body 61, and overlies the lighting module 7 to permit passage of a light beam emanating from the lamp set 72 therethrough. Referring to FIG. 3, the translucent lamp shade 8 cooperates with the skirt 32 to hide the lighting module 7 from sight so as to provide an improved outer appearance. Further, the translucent lamp shade 8 has a handgrip 81 which extends outwardly and radially of the rim body 61 to facilitate swiveling and turning of the rim body 61 and the lighting module 7.

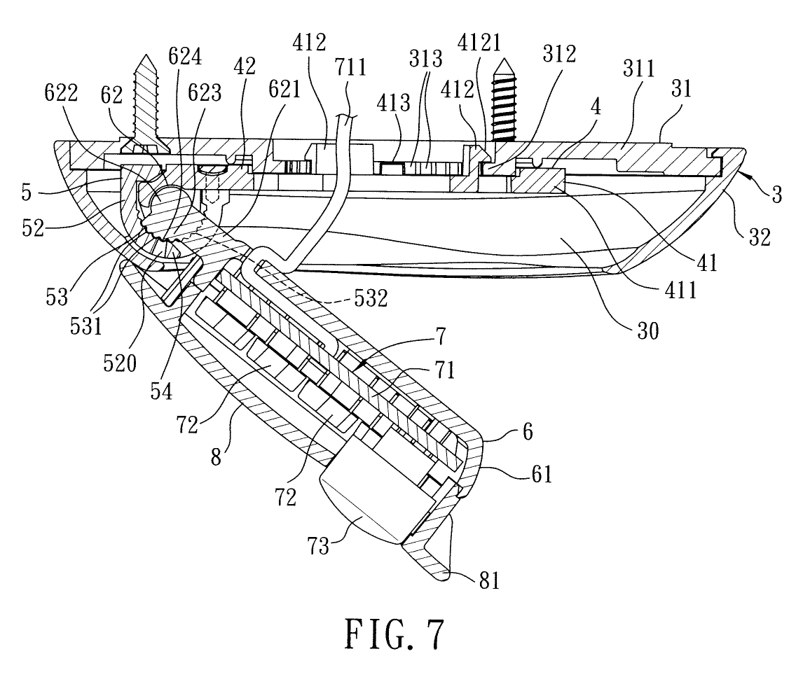

As shown in FIGS. 2, 3 and 7, in assembly, the base plate 31 is first secured to a mounting wall using screws or adhesive. Subsequently, the swivelable carrier 4, on which the retaining member 5, the mounting frame 6, the lighting module 7 and the lamp shade 8 are mounted, is fitted to the base plate 31. Moreover, the skirt 32 is secured to the base plate 31, and the circuit board 71 is electrically connected to a power supply through the electric wire 711. The lamp set 72 can be controlled by operation of the switch 73.

When it is desired to change the angle of the lighting module 7, the handgrip 81 is pulled so that the lamp shade 8 and the mounting frame 6 are turned about the hinge axis to a desired tilted position, and the second serrations 624 are moved to be engaged with the left retaining region 531 of the retaining surface 53 to thereby retain the mounting frame 6 at the tilted position.

When it is desired to change the direction of the lighting module 7, the lamp shade 8 is pressed to cause the mounting frame 6 to turn so as to permit the swivelable carrier 4 to swivel relative to the base unit 3 about the central axis. By means of the engagement between the engaging protrusions 413 and the first serrations 313, the swivelable carrier 4 is retained at the desired retaining position.

As illustrated, by operating the lamp shade 8, the angle and the direction of the lighting module 7 can be changed. In addition, by virtue of the first and second slidably engaging units, the lamp device is retained in place once the angle and direction adjustment is completed. Further, compared with the aforementioned prior art, the lamp device of this invention has fewer components, and can be manufactured and assembled at reduced manufacturing costs.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A lamp device comprising:
a base plate adapted to be fixed onto a mounting wall, and having a major plate surface opposite to the mounting wall along a central axis;
a swivelable carrier which has a carrier body that is disposed normal to the central axis, and that has front and rear major carrier surfaces opposite to each other along the central axis, and a joint lug disposed outwardly and radially of said carrier body;
a revolution enabling unit disposed between said base plate and said rear major carrier surface to enable said carrier body to swivel relative to said base plate about the central axis, and including a socket member which has an inner tubular surface surrounding the central axis, and a plug member which is configured to be fitted to said socket member such that said plug member is prevented from disengaging from said socket member along the central axis during swiveling movement of said carrier body;
a first slidably engaging unit which is disposed between said inner tubular surface and said swivelable carrier, and which is configured to guard against the swiveling movement of said carrier body relative to said inner tubular surface at a selected one of a plurality of retaining positions that are angularly displaced from one another about the central axis;
an angularly positionable mounting frame disposed to be swiveled with said carrier body about the central axis, said mounting frame including a rim body surrounding the central axis, and a hinge shaft which is disposed outwardly of said rim body and which is hingedly mounted on said joint lug about the hinge axis such that said rim body is turnable relative to said carrier body about the hinge axis to a selected one of a plurality of tilted positions that are angularly displaced from one another about the hinge axis, said hinge shaft having a surrounding outer surface which is revolveable about the hinge axis;
a second slidably engaging unit which is configured to guard against revolving movement of said surrounding outer surface relative to said joint lug at the selected one of the tilted positions; and
a lighting module surrounded by and secured to said rim body.

2. The lamp device according to claim 1, wherein said major plate surface of said base plate has a central region which defines a central bore that extends along the central axis through said base plate to form said inner tubular surface of said socket member, said plug member defining a surrounding contour line, and having a plurality of tongues which are angularly displaced from one another along the surrounding contour line, each of said tongues extending from said rear major carrier surface and terminating at a hook end such that, when said plug member is snap-fitted into said central bore, said hooked ends of said tongues are disposed beneath said base plate, and such that the surrounding contour line confronts said inner tubular surface in radial directions.

3. The lamp device according to claim 2, wherein said first slidably engaging unit includes a plurality of engaging protrusions which extend rearwardly from said rear major carrier surface and which are angularly spaced apart from each other along the surrounding contour line, and a plurality of first serrations which are disposed on said inner tubular surface such that said engaging protrusions are angularly displaceable relative to, and are frictionally engaged with, said first serrations so as to retain said carrier body at the selected one of the retaining positions.

4. The lamp device according to claim 2, wherein said joint lug has a joint surface which extends angularly about the hinge axis, said hinge shaft including a cylindrical body which is pivotably connected to said joint surface about the hinge axis such that said surrounding outer surface is revolveable about the hinge axis,
said second slidably engaging unit including a plurality of second serrations which are disposed on said surrounding outer surface and which are angularly displaced from one another about the hinge axis, and a retaining member which has an anchoring base that is secured to said joint lug, a jaw body that extends angularly from said anchoring base about the hinge axis, and a retaining surface that confronts radially and that is serrated to mate with said second serrations in frictional engagement to thereby guard against revolving movement of said surrounding outer surface relative to said joint lug at the selected one of the tilted positions.

5. The lamp device according to claim 4, wherein said jaw body has a slit which extends through said retaining surface and in a transverse direction parallel to the hinge axis to divide said retaining surface into left and right retaining regions so as to vest said jaw body with a flexibility for facilitating engagement between one of said left and right retaining regions and said second serrations.

6. The lamp device according to claim 5, wherein said jaw body includes an engaging finger which extends from one of said left and right retaining regions in the transverse direction and which is configured to engage said second serrations so as to reinforce the engagement between the retaining surface and said second serrations at the selected one of the tilted positions.

7. The lamp device according to claim 1, further comprising a translucent lamp shade which is secured to said rim body and which overlies said lighting module so as to permit passage of a light beam emanating from said lighting module.

8. The lamp device according to claim 7, wherein said rim body has hooks which are angularly displaced from one another about the central axis, said translucent lamp shade having engaging holes which are angularly displaced from one another about the central axis, each of said hooks being engaged with a respective one of said engaging holes so as to secure said translucent lamp shade to said rim body.

9. The lamp device according to claim 8, wherein said translucent lamp shade has a handgrip which extends outwardly and radially of said rim body to facilitate swiveling and turning operations.

10. The lamp device according to claim 7, further comprising a skirt which surrounds the central axis, which extends rearwardly to terminate at a flared rear edge that is securely mounted on said major plate surface of said base plate, and which extends forwardly to terminate at a surrounding front edge that cooperates with said translucent lamp shade to hide said lighting module from sight.
